(19) United States
(12) Patent Application Publication
(10) Pub. No.: US 2005/0082769 A1
(43) Pub. Date: Apr. 21, 2005

(54) Bellows arrangement

(76) Inventors: Thorsten Scholtz, Bad Honnef (DE); Joachim Wette, Hennef (DE)

Correspondence Address: Robert P Renke;Artz & Artz, Suite 250, 28333 Telegraph Road, Southfield, MI, 48034, US

(21) Appl. No.: 10/343,528

(22) PCT Filed: Jan. 19, 2002
(86) PCT No.: PCT/EP02/00491

(30) Foreign Application Priority Data
Mar. 14, 2001 (DE) 101 12 212.8
May 12, 2001 (DE) 101 23 216.0

(51) Int. Cl. F16J 3/00

(52) U.S. Cl. 277/635

(57) ABSTRACT

A convoluted boot assembly 20 which is provided for a tripode joint unit, which has to seal an annular gap between an outer joint part 12 and a shaft 19 connected to an inner joint part 16 and which comprises a rotationally symmetric convoluted boot 25 extending between a first end for being fixed on the outer joint part 12 and a second end for being fixed on the shaft 19, and an adapter ring 21 which, by means of an inner face 31, in its cross-section, can be slipped form-fittingly on to the outer joint part 12, wherein, by means of its first end, the convoluted boot 25 is directly secured to the end face 22 of the adapter ring 21, which end face 22 surrounds the aperture 15 of the outer joint part 12.

The invention relates to a convoluted boot assembly which is provided for a tripode joint unit, which has to seal an annular gap between an outer joint part and a shaft connected to an inner joint part and which comprises a rotationally symmetric convoluted boot extending between a first end for being fixed on the outer joint part and a second end for being fixed on the shaft, and an adapter ring which, by means of an inner face, in its cross-section, can be slipped form-fittingly on to the outer joint part and consists of a non-metallic material.

Convoluted boots blow-moulded from a piece of hose can, substantially, be produced only in a completely rotationally symmetric shape and even the process of forming thickened portions for the collar regions requires special measures.

In consequence, the seats of the attachment regions of the convoluted boots produced in this way also necessarily require a rotationally symmetric cross-section.

The outer circumference of the aperture end of an outer joint part of a tripode joint has a clover-leaf-like cross-section, i.e. in accordance with the tripode arms and roller assemblies of the inner joint part, it comprises three raised portions and cuts distributed across the circumference at uniform pitch angles. It therefore does not meet the precondition for allowing blow-moulded convoluted boots to be slipped on directly.

It is therefore common practice to produce adapter rings which, by means of their inner faces, are slipped on to the clover-leaf-shaped outer face of the outer joint part and which provide a rotationally symmetric seat face for the convoluted boot, on which seat face the convoluted boot can be secured by means of a tensioning strip or clamping ring. Normally the adapter ring is first secured on the outer joint part, and during the assembly of the inner joint part and outer joint part, the convoluted boot is tightened on the adapter ring with its larger collar. Because several parts are involved, it is necessary to provide the respective number of production stages for producing the individual parts and a corresponding number of assembly stages when assembling and completing the tripode joint.

From U.S. Pat. No. 6,089,574 there are known assemblies consisting of adapter rings and convoluted boots of the above-mentioned type which, via complementary annular toothings in the seat faces, engage one another in a form-fitting way. Adapter ring and convoluted boot assemblies can be pre-assembled prior to assembling the tripode joint.

U.S. Pat. No. 6,099,788 describes assemblies consisting of adapter rings and convoluted boots of a similar type wherein the seat faces are substantially cylindrical and wherein a material-locking connection between the two parts is achieved by a thermal method. Such assemblies consisting of an adapter ring and a convoluted boot must be completed prior to the assembly of the tripode joints.

It is therefore the object of the present invention to provide a simplified design of a convoluted boot assembly which leads to a reduction in the dimensions of the space required for assembly purposes and to a reduction in the number of parts. The objective is achieved in that, by means of its first end, the convoluted boot is directly secured to the end face of the adapter ring, which end face surrounds the aperture of the outer joint part, directly secured meaning a form fitting and/or material-locking connection without the use of additional components, but it does not exclude the use of glue in a material-locking connection. There is no longer any need for the adapter ring and the convoluted boot having to be inserted into one another, which would lead to increased installation diameters of the finished tripode joint. As a result of the direct connection between the two parts, which connection can be of the form-fitting or material-locking type, additional connecting elements can be eliminated. The connection can preferably be effected prior to the assembly of the joint, so that when inserting the inner joint part into the outer, joint part, only the adapter ring firmly connected to the convoluted boot has to be slipped on to the outer joint part.

In a preferred embodiment, the outer diameter of the adapter ring is greater than/equal to the outer diameter of the convoluted boot, which means that the greatest outer diameter of the joint structure is minimised down to the outer diameter required for the adapter ring.

Whereas, normally, the convoluted boot is blow-moulded without, however, excluding other production methods, the adapter ring is preferably injection-moulded.

Depending on the production method and quality requirements, the convoluted boot and the adapter ring can consist of thermoplastic elastomer, of rubber or of mixtures of the two materials. The adapter ring can also consist of a hard thermoplast. Rubber admixtures improve the gluing ability of the product.

The adapter ring and convoluted boot can be thermally welded or glued together. As far as the form-fitting engagement or force-locking connection between the two parts is concerned, the following preferred embodiments will be mentioned:
the convoluted boot can be provided with a cylindrical collar and, by means of a butt joint, it can be attached to an annular cylindrical projection at the end face of the adapter ring;
the convoluted boot can be provided with a cylindrical collar which engages an internally cylindrical widening in the end face of the adapter ring;
at its cylindrical collar, the convoluted boot can comprise an outer bead which engages a radial groove in the internally cylandrical widening in the end face of the adapter ring;
at its cylindrical collar, the convoluted boot can be provided with an inner bead which engages a radial groove in the cylindrical outer face of the adapter ring;
the convoluted boot can be provided with a cylindrical collar which engages an annular groove in the end face of the adapter ring, and the convoluted boot can be provided with a radial face which adjoins the cylindrical collar and rests against *the end face of the adapter ring;
the convoluted boot can comprise an annular bead which is form-fittingly inserted into an annular groove in the end face of the adapter ring which annular groove becomes narrower towards the end face;
the convoluted boot can form a radial flange which rests against the end face of the adapter ring in a planar way and is connected thereto in a material-locking way.

In all its embodiments, the adapter ring can comprise an inner step which can be made to contact the end face of the outer joint part, which end face is positioned at the aperture end of the outer joint part. In all its embodiments, the adapter ring, in its inner face, preferably comprises at least one continuous sealing lip to establish a sealing contact with the outer joint part. In this way it is ensured that no dirt can pass between the outer joint part and the adapter ring into the joint and that no lubricant can escape from the joint.

Preferred embodiments of the invention are illustrated in the drawings and will be described below.

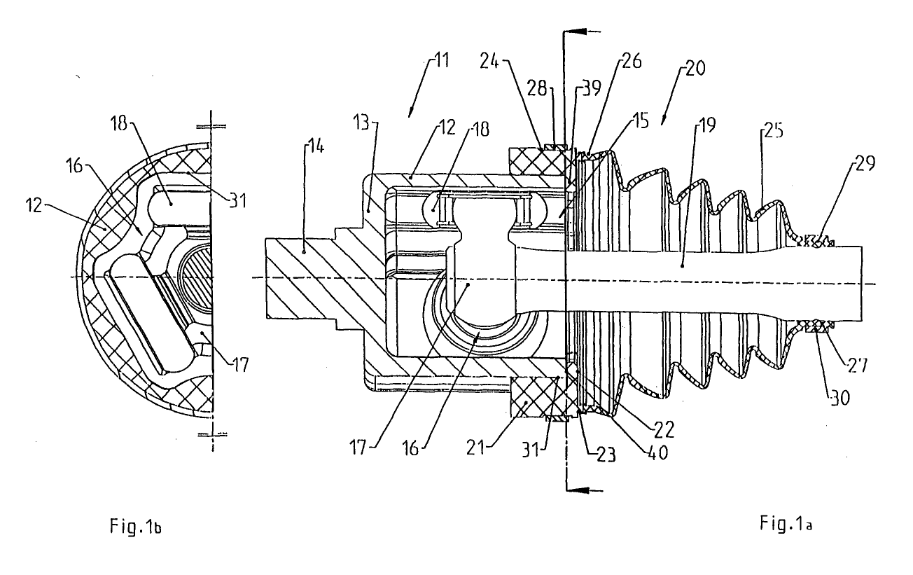

FIG. 1 shows a tripode joint with an inventive assembly
a) in a longitudinal section,
b) in half a cross-section.

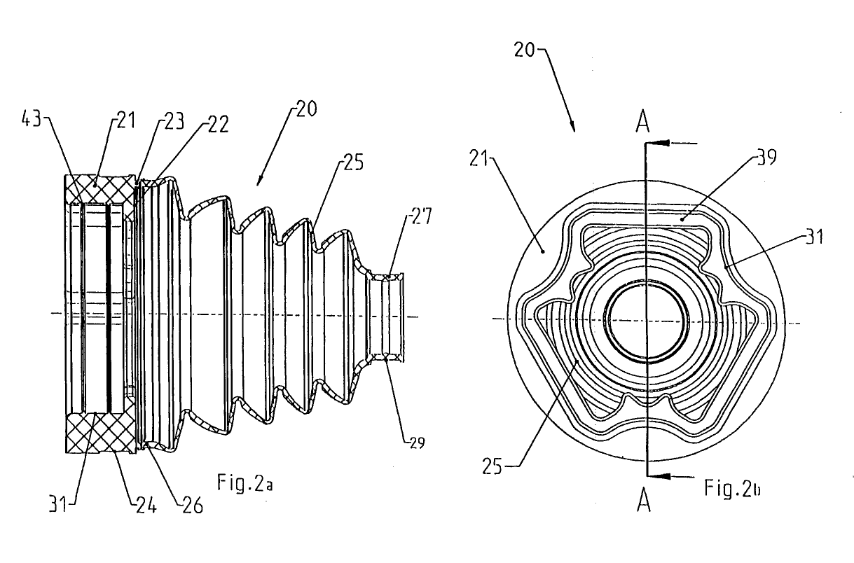

FIG. 2 shows an inventive assembly according to FIG. 1 in the form of a detail
a) in a longitudinal section,
b) in an end view.

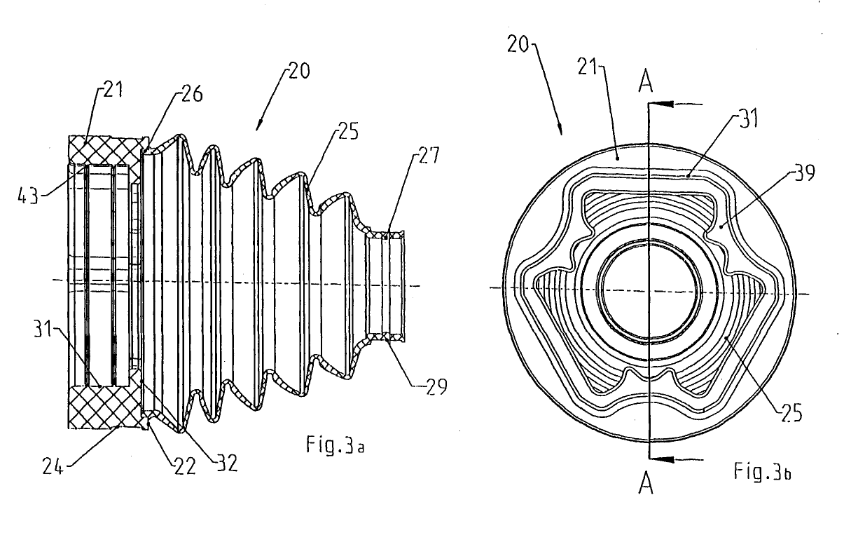

FIG. 3 shows an inventive assembly in the form of a detail in a second embodiment
a) in a longitudinal section,
b) in an end view.

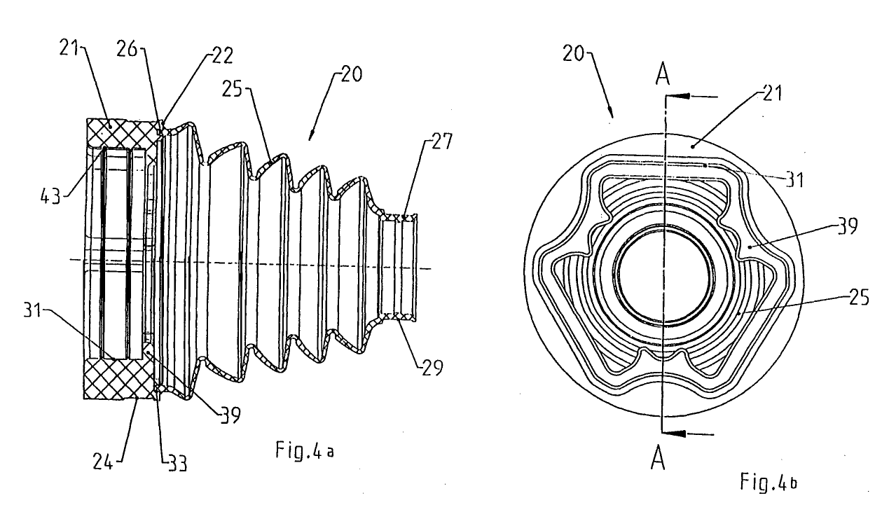

FIG. 4 shows an inventive assembly in the form of a detail in a third embodiment
a) in a longitudinal section,
b) in an end view.

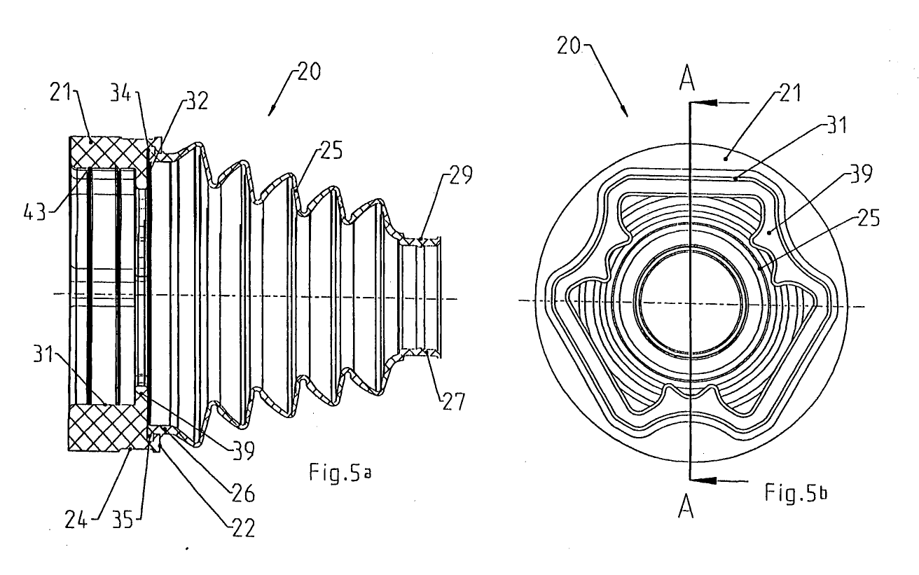

FIG. 5 shows an inventive assembly in the form of a detail in a fourth embodiment
a) in a longitudinal section

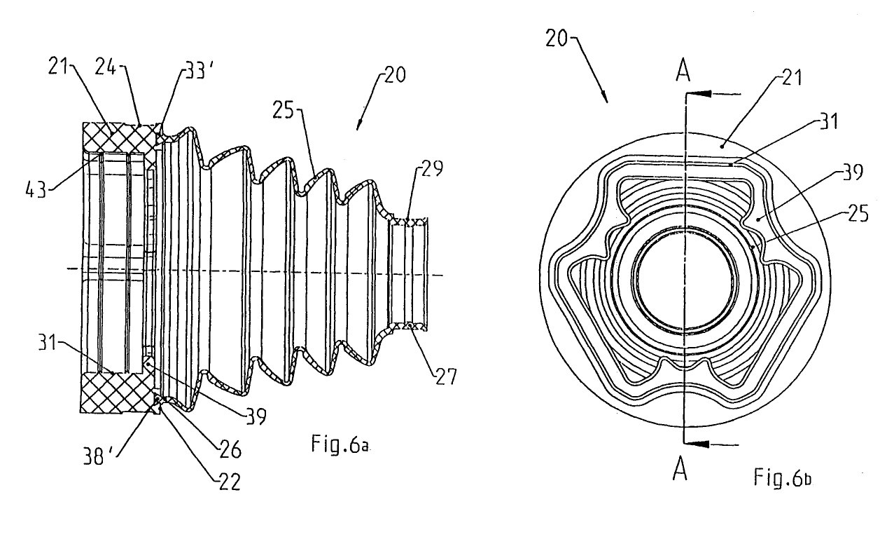

FIG. 6 shows an inventive assembly in the form of a detail in a fifth embodiment
a) in a longitudinal section
b) in the form of an end view.

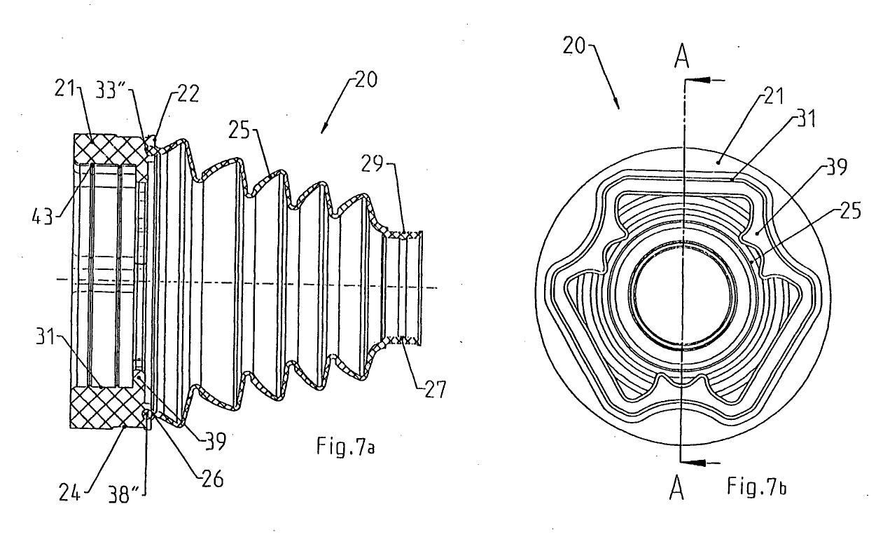

FIG. 7 shows an inventive assembly in the form of a detail in a sixth embodiment
a) in a longitudinal section
b) in an end view.

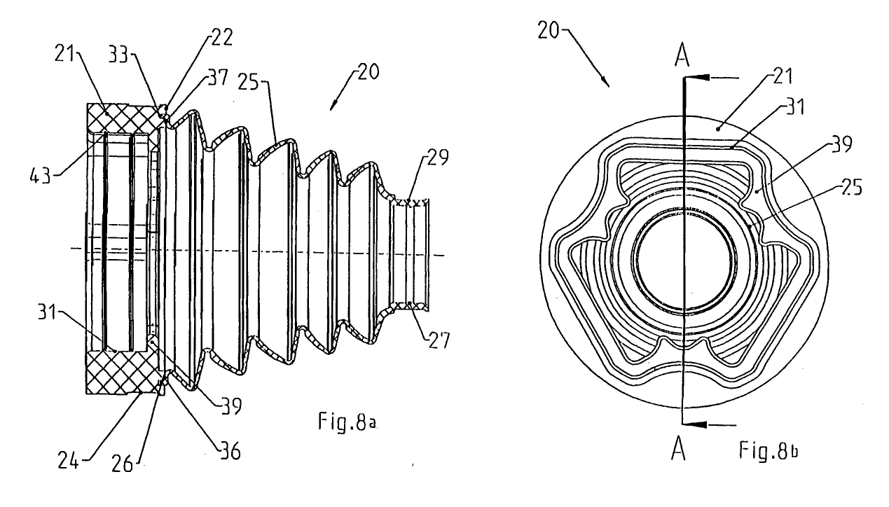

FIG. 8 shows an inventive assembly in the form of a detail in a seventh embodiment
a) in a longitudinal section,
b) in an end view.

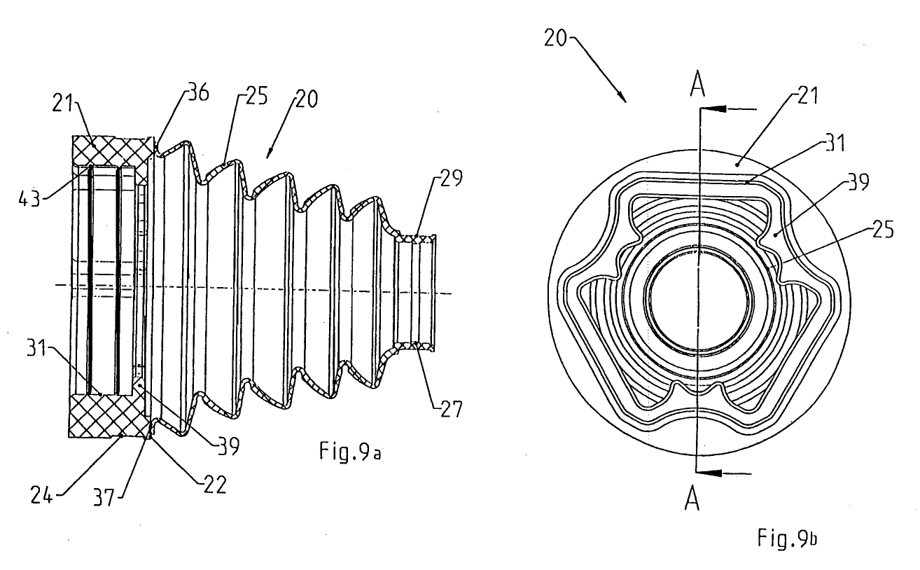

FIG. 9 shows an inventive assembly in the form of a detail in an eighth embodiment
a) in a longitudinal section,
b) in an end view.

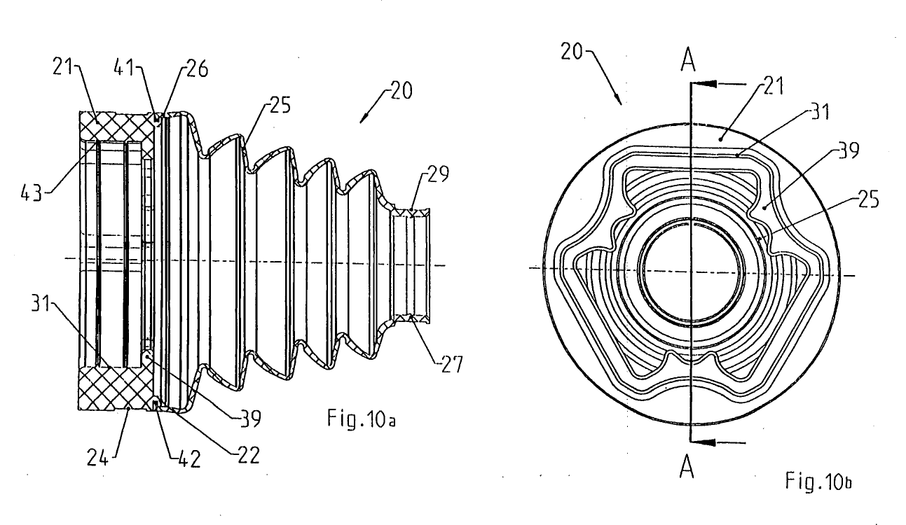

FIG. 10 shows an inventive assembly in the form of a detail in a ninth embodiment
a) in a longitudinal section
b) in an end view.

FIG. 1 shows a tripode joint assembly 11 with an inventive convoluted boot assembly 20 in two illustrations. The tripode joint 11 comprises an outer joint part 12 whose outer contour has a clover-leaf-shaped cross-section and which comprises a closing base 13 and an attached journal 14. At the end axially opposed to the base, there is provided aperture 15. The outer part 12 is engaged by an inner joint part 16 comprising a tripode star 17 and roller assemblies 18. A shaft 19 is inserted into the tripode star 17. The assembly consisting of the inner joint part 16 and the shaft 18 is held in the outer joint part 12 so as to be axially displaceable and angularly movable. In the region of the aperture 15 an adapter ring 21 is slid on to the outer joint part 12 whose outside comprises a clover-leaf-shaped cross-section. The outside of the adapter ring 21 is cylindrical and its inner face 31 is adapted to the clover-leaf-shaped contour of the outer joint part 12. On its inner face 31, the adapter ring 21 comprises two continuous, axially offset sealing lips which are flattened when the adapter ring 21 is slid on to the outer joint part 12 and which, in consequence, are not visible in FIG. 1. The sealing lips serve to seal the gap between the outer joint part 12 and the adapter ring 21. The inner face 31 of the adapter ring 21 is delimited by a radially inwardly pointing inner step 39 which, while the adapter ring 21 is being slid on, comes to rest against the end face 40 of the outer joint part 12. Inside the outer contour of the adapter ring 21, a cylindrical projection 23 is formed on to the end face 22 of the adapter ring 21. The joint space between the outer joint part, 12 and the shaft 19 is bridged by a convoluted boot 25 which is a completely rotationally symmetric blow-moulded part. A first collar 26 of the convoluted boot 25, by means of a butt joint, is attached to the annular cylindrical projection 23 of the adapter ring 21. A second collar 27 is sealingly positioned on the shaft 19. On its outside, the adapter ring 21 comprises an annular groove 24 which is engaged by a tensioning strip 28 for fixing the adapter ring 21 on the outer joint part 12. The second collar 27 comprises an annular groove 29 and is secured by a tensioning strip 30 on the shaft 19.

FIG. 2, in the form of a detail, shows a convoluted boot assembly 20 consisting of an adapter ring 21 and a convoluted boot 25. Identical details have been given the same reference numbers as in FIG. 1. The longitudinal section according to a) shows the cylindrical inner face 31 of the adapter ring 21, which inner face 31 can be slid on to the outer joint part so as to be delimited by the inner step 39. The end view according to b) shows the clover-leaf-shaped cross-section of the inner face 31 of the adapter ring 21.

As already described above, the cylindrical projection 23 at the end face 22 of the adapter ring 21 is connected by means of a butt joint to the first collar 26 of the convoluted boot 25, said connection being effected by thermal welding.

In FIG. 3, any details identical to those in FIG. 2 have been given the same reference numbers. At its end face, the adapter ring 21 with its clover-leaf-shaped inner contour and its cylindrical outer contour is provided with an internally cylindrical widening 32 which is engaged by the first collar 26 of the convoluted boot 25. The connection between the adapter ring 21 and the convoluted boot 25 can be a welded or glued connection.

In FIG. 4, any details identical to those shown in FIG. 2 have been given the same reference numbers. In the end face 22 of the adapter ring 21, there is provided a rectangular annular groove 33 which is engaged by the first cylindrical collar 26 of the convoluted boot 25. The connection between the convoluted boot 25 and the adapter ring 21 can be a welded or glued connection.

In FIG. 5, any details identical to those shown in FIG. 2 have been given the same reference numbers. In its end face 22, the adapter ring 21 comprises an internally cylindrical widening 32 with a rectangular annular groove 34 which is engaged by an outer bead 35 at the collar 26 of the convoluted boot 25.

In FIG. 6, any details identical to those shown in FIG. 2 have been given the same reference numbers. On the end face of the adapter ring 21, there is provided an annular groove 33′ whose cross-section is widened swallow-tail-like, starting from the end face 22. Analogously, the collar 26 of the convoluted boot 25, towards the end of same, is widened into a swallow-tail-like annular bead 38′ and form-fittingly engages the annular groove 33′.

In FIG. 7, any details identical to those shown in FIG. 2 have been given the same reference numbers. In its end face 22, the adapter ring 21 comprises an annular groove 33″ whose cross-section, starting from the end face 22, is widened in a trough-shaped way and which is form-fittingly engaged by the convoluted boot 25 by means of a torus-shaped annular bead 38″ at the collar 26.

In FIG. 8, any details identical to those shown in FIG. 2 have been given the same reference numbers. In its end face 22, the adapter ring 21 comprises a rectangular groove 33 which is engaged by the convoluted boot 25 by means of its cylindrical collar 26. The collar 26 of the convoluted boot 25 is followed by a radial face 36 which is connected by a welded or glued connection 37 to the end face 22 of the adapter ring 21.

In FIG. 9, any details identical to those shown in FIG. 2 have been given the same reference numbers. The end face 22 of the adapter ring 21 is completely planar. Instead of a collar, the convoluted boot comprises a final radial face 36 which is connected by a welded or glued connection 37 to the end face 22 of the adapter ring 21.

In FIG. 10, any details identical to those shown in FIG. 2 have been given the same reference numbers. Initially, towards its end face 22, the adapter ring 21 comprises a radial groove 42 in a cylindrical outer face. The radial groove 42 which comprises a rectangular contour is engaged by an inner bead 41 at the collar 26 of the convoluted boot 25.

| | |
|---|---|
| GKN Automotive GmbH | Jan. 16, 2002 |
| Hauptstrasse 150 | Ne/bec (20020021) |
| 53797 Lohmar | Q01024WO10 |

### Convoluted Boot Assembly

List of Reference Numbers

11 tripode joint
12 outer joint part
13 base
14 journal
15 aperture
16 inner joint part
17 tripode star
18 roller assembly
19 shaft
20 convoluted boot assembly
21 adapter ring
22 end face
23 cylindrical projection
24 annular groove
25 convoluted boot
26 collar (large)
27 collar (small)
28 tensioning strip
29 annular bead
30 tensioning strip
31 inner face
32 widening
33, 33′ 33″ annular groove
34 radial groove
35 outer bead
36 radial face
37 glued region
38, 38′,38″ annular bead
39 inner step
40 end face
41 inner bead
42 radial groove
43 sealing lip

1. A convoluted boot assembly (20) which is provided for a tripode joint unit, which has to seal an annular gap between an outer joint part (12) and a shaft (19) connected to an inner joint part (16) and which comprises a rotationally symmetric convoluted boot (25) extending between a first end for being fixed on the outer joint part (12) and a second end for being fixed on the shaft (19), and an adapter ring (21) from a non-metallic material which, by means of an inner face (31), in its cross-section, can be slipped form-fittingly on to the outer joint part (12),
characterised in
that, by means of its first end, the convoluted boot (25) is directly secured to the end face (22) of the adapter ring (21), which end face (22) surrounds the aperture (15) of the outer joint part (12).

2. An assembly according to claim 1,
characterised in
that the outer diameter of the adapter ring (21) is greater than/equal to the outer diameter of the convoluted boot (25).

3. An assembly according to any one of claims 1 or 2,
characterised in
that the convoluted boot (25) is provided with a cylindrical collar (26) and, by means of a butt joint; is attached to an annular cylindrical projection (23) at the end face (22) of the adapter ring (21). (FIG. 2).

4. An assembly according to any one of claims 1 or 2,
characterised in
that the convoluted boot (25) is provided with a cylindrical collar (26) which engages an internally cylindrical widening (32) in the end face (22) of the adapter ring (21). (FIG. 3).

5. An assembly according to claim 4,
characterised in
that, at its cylindrical collar (26), the convoluted boot (25) is provided with an outer bead (35) which engages a radial groove (34) in the internally cylindrical widening (32) in the adapter ring (21). (FIG. 5).

6. An assembly according to any one of claims 1, 2 or 4,
characterised in
that, at its cylindrical collar (16), the convoluted boot (25) is provided with an inner bead (41) which engages a radial groove (42) in the cylindrical outer face of the adapter ring (21). (FIG. 10).

7. An assembly according to any one of claims 1 or 2,
characterised in
that the convoluted boot is provided with a cylindrical collar (26) which engages an annular groove (33) in the end face (22) of the adapter ring (21). (FIG. 4)

8. An assembly according to claim 7,
characterised in
that the convoluted boot (25) is provided with a radial face (36) which adjoins the cylindrical collar (26) which rests against the end face (22) of the adapter ring (21). (FIG. 8)

9. An assembly according to any one of claims 1 or 2,
characterised in
that the convoluted boot (25) comprises an annular bead (38′, 38″) which is form-fittingly inserted into an annular groove (33′, 33″) in the end face (22) of the adapter ring (21), which annular groove becomes narrower towards the end face (22). (FIGS. 6, 7).

10. An assembly according to any one of claims 1 or 2,
characterised in
that the convoluted boot (25) forms a radial flange (36) which rests against the end face (22) of the adapter ring (21) in a planar way and is connected thereto in a material-locking way. (FIGS. 8, 9).

11. An assembly according to any one of claims 1 to 10,
characterised in
that the adapter ring (21) comprises an inner step (39) which comes to rest against the end face (40) of the outer jointpart, which end face (40) is positioned at the aperture end of the outer joint part.

12. An assembly according to any one of claims 1 to 11,
characterised in
that the convoluted boot (25) is blow-moulded.

13. An assembly according to any one of claims 1 to 12,
characterised in
that the adapter ring (21) is injection-moulded.

14. An assembly according to any one of claims 1 to 13,
charactertised in
that the adapter ring (21) and the convoluted boot (25) are thermally welded to one another.

15. An assembly according to any one of claims 1 to 13,
characterised in
that the adapter ring (21) and the convoluted boot (25) are glued to one another.

16. An assembly according to any one of claims 1 to 15,
characterised in
that, at its inner face (31), the adapter ring (21) comprises at least one continuous sealing lip (43) for providing sealing contact with the outer joint part (12).

17. An assembly according to any one of claims 1 to 16,
characterised in
that the convoluted boot (25) consists of a thermoplastic elastomer or of rubber or of mixtures of the two above-mentioned materials.

18. An assembly according to any one of claims 1 to 17,
characterised in
that the adapter ring (21) consists of a thermoplastic, especially of thermoplast elastomer, of rubber or of mixtures of the two above-mentioned materials.
